(19) United States
(12) Patent Application Publication
(10) Pub. No.: US 2019/0106163 A1
(43) Pub. Date: Apr. 11, 2019

(54) METHODS AND SYSTEMS TO ADJUST UNDERBODY ACTIVE SURFACES

(71) Applicant: GM GLOBAL TECHNOLOGY OPERATIONS LLC, Detroit, MI (US)

(72) Inventors: Jason D. Fahland, Fenton, MI (US); Joshua R. Auden, Brighton, MI (US)

(21) Appl. No.: 15/728,625

(22) Filed: Oct. 10, 2017

(51) Int. Cl. B62D 35/00; B62D 35/02

(52) U.S. Cl. CPC B62D 35/005; B62D 35/02; B60Y 2300/0954; B60Y 2400/3017; B60Y 2300/085; B60Y 2400/40

(57) ABSTRACT

In an exemplary embodiment, a method for controlling a vehicle includes the steps of receiving, by a vehicle controller, sensor data representing a vehicle environment along a projected path of travel of the vehicle from at least one sensor, determining, by the vehicle controller, if the projected path of travel of the vehicle includes an obstacle, determining, by the vehicle controller, if an underbody component of the vehicle will impact the obstacle, and if the underbody component will impact the obstacle, generating, by the vehicle controller, a control signal to move the underbody component from a first position to a second position.

### INTRODUCTION

The present invention relates generally to the field of vehicles and, more specifically, to aerodynamic features of automotive vehicles.

As an automotive vehicle travels, it disturbs the air through which it passes. This air disturbance has an impact on energy consumption of the automotive vehicle, among other factors. Overcoming wind resistance and turbulence generated by the passage of the vehicle expends energy, which must be obtained from fuel, electricity, or other stored energy of the vehicle. The greater the wind resistance and turbulence, the greater the expenditure of fuel and the lower the fuel economy. Vehicles are therefore generally designed with aerodynamic performance in mind. In conventional vehicle design aerodynamic features were generally fixed body structures on the exterior of the vehicle. However, recently, actively movable aerodynamic features have been implemented on some vehicles.

### SUMMARY

Embodiments according to the present disclosure provide a number of advantages. For example, embodiments according to the present disclosure enable adjustment of the position of an aerodynamic feature of an automotive vehicle in response to sensor information indicating a possible impact with an obstacle along the projected path of travel of the vehicle.

In one aspect, a method of controlling a vehicle includes the steps of providing a vehicle having a body with an underbody space between a lower surface of the body and a driving surface, providing a moveable underbody feature at the lower surface, the moveable underbody feature having a first position and a second position, the first position presenting a deployed profile in the underbody space and the second position presenting a stowed profile in the underbody space, the second position distinct from the first position, providing an actuator coupled to the moveable underbody feature and configured to drive the moveable underbody feature between the first position and the second position, providing at least one sensor configured to detect an environmental condition, providing a controller in communication with the actuator and the at least one sensor, and in response to the detected environmental condition, automatically moving the moveable underbody feature, via the actuator, between the first position and the second position.

In some aspects, the environmental condition includes a detected obstacle along a projected path of travel of the vehicle.

In some aspects, the method of claim 1, further includes, in response to the detected environmental condition, automatically moving the moveable underbody feature, via the actuator, to an intermediate position between the first position and the second position.

In some aspects, providing at least one sensor includes providing at least one short range RADAR sensor.

In some aspects, providing at least one sensor includes providing at least one long range RADAR sensor.

In some aspects, providing at least one sensor includes providing at least one ultrasonic sensor.

In some aspects, providing at least one sensor includes providing at least one optical camera.

In another aspect, an automotive vehicle includes a body having a lower surface, a plurality of vehicle wheels disposed at the lower surface, each respective wheel of the plurality of wheels having a respective contact surface for contacting a driving surface, an underbody space being defined between the contact surfaces and the lower surface of the body, a moveable underbody feature coupled to the lower surface and projecting into the underbody space, the moveable underbody feature having a first position and a second position, the first position presenting a deployed profile in the underbody space and the second position presenting a stowed profile in the underbody space, the second position distinct from the first position, at least one sensor configured to capture sensor data representing a vehicle environment, an actuator coupled to the moveable underbody feature and configured to drive the moveable underbody feature between the first position and the second position, and a controller in communication with the at least one sensor and the actuator, the controller configured to analyze the sensor data for an environmental condition and, if the analyzed data includes the environmental condition, control the actuator to move the moveable underbody feature from the first position to the second position.

In some aspects, the moveable underbody feature additionally has an intermediate position between the first position and the second position, and wherein the controller is further configured to, in response to the environmental condition, control the actuator to move the moveable underbody feature to the intermediate position.

In some aspects, the at least one sensor includes an optical camera configured to capture image data of an area along a projected path of travel of the vehicle, wherein the environmental condition includes an obstacle identified along the projected path of travel.

In some aspects, the at least one sensor includes a short range RADAR sensor configured to capture data of an area along a projected path of travel of the vehicle, wherein the environmental condition includes an obstacle identified along the projected path of travel.

In some aspects, the at least one sensor includes a long range radar configured to capture data of an area along a projected path of travel of the vehicle, wherein the environmental condition includes an obstacle identified along the projected path of travel.

In some aspects, the at least one sensor includes an ultrasonic sensor configured to capture data of an area along a projected path of travel of the vehicle, wherein the environmental condition includes an obstacle identified along the projected path of travel.

In yet another aspect, a method for controlling a vehicle includes the steps of receiving, by a vehicle controller, sensor data representing a vehicle environment along a projected path of travel of the vehicle from at least one sensor, determining, by the vehicle controller, if the projected path of travel of the vehicle includes an obstacle, determining, by the vehicle controller, if an underbody component of the vehicle will impact the obstacle, and if the underbody component will impact the obstacle, generating, by the vehicle controller, a control signal to move the underbody component from a first position to a second position.

In some aspects, receiving data from at least one sensor includes receiving image data from an optical camera and wherein determining if the projected path of travel of the vehicle includes an obstacle includes analyzing, by the vehicle controller, the image data received from the optical camera to identify the obstacle.

In some aspects, determining if an underbody component of the vehicle will impact the obstacle includes comparing, by the vehicle controller a clearance height of the vehicle with an estimated height of the obstacle, wherein the estimated height of the obstacle is determined from the sensor data.

In some aspects, receiving data from at least one sensor includes receiving data from a RADAR sensor and wherein determining if the projected path of travel of the vehicle includes an obstacle includes analyzing, by the vehicle controller, the data received from the RADAR sensor to identify the obstacle.

In some aspects, receiving data from at least one sensor includes receiving data from an ultrasonic sensor and wherein determining if the projected path of travel of the vehicle includes an obstacle includes analyzing, by the vehicle controller, the data received from the ultrasonic sensor to identify the obstacle.

### BRIEF DESCRIPTION OF THE DRAWINGS

The present disclosure will be described in conjunction with the following figures, wherein like numerals denote like elements.

FIG. 1 is a schematic view of an automotive vehicle, according to an embodiment.

FIG. 2 is a block diagram of a system for controlling an underbody surface of an automotive vehicle, according to an embodiment.

FIGS. 3A and 3B are schematic side view representations of an automotive vehicle, according to an embodiment.

FIG. 4 is a flowchart of a method of controlling an underbody surface of an automotive vehicle, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above derivatives thereof, and words of similar import.

Currently, between downforce-generating underbody components on performance cars and drag-reduction underbody components on high volume vehicles, there is considerable chance for damage from impact with road obstacles. Many of these components are active component systems configured to adjust position to both increase the performance envelope and reduce drag for increased fuel economy, making the systems even more expensive to replace.

Modern vehicles include a suite of sensors configured to identify objects in the pathway of the vehicle that are determined to pose a risk of impacting an underbody component. As discussed in greater detail herein, a vehicle controller can analyze the sensor data, determine whether an impact is likely, and control an actuator to move the active component to a protected position to avoid the potential impact.

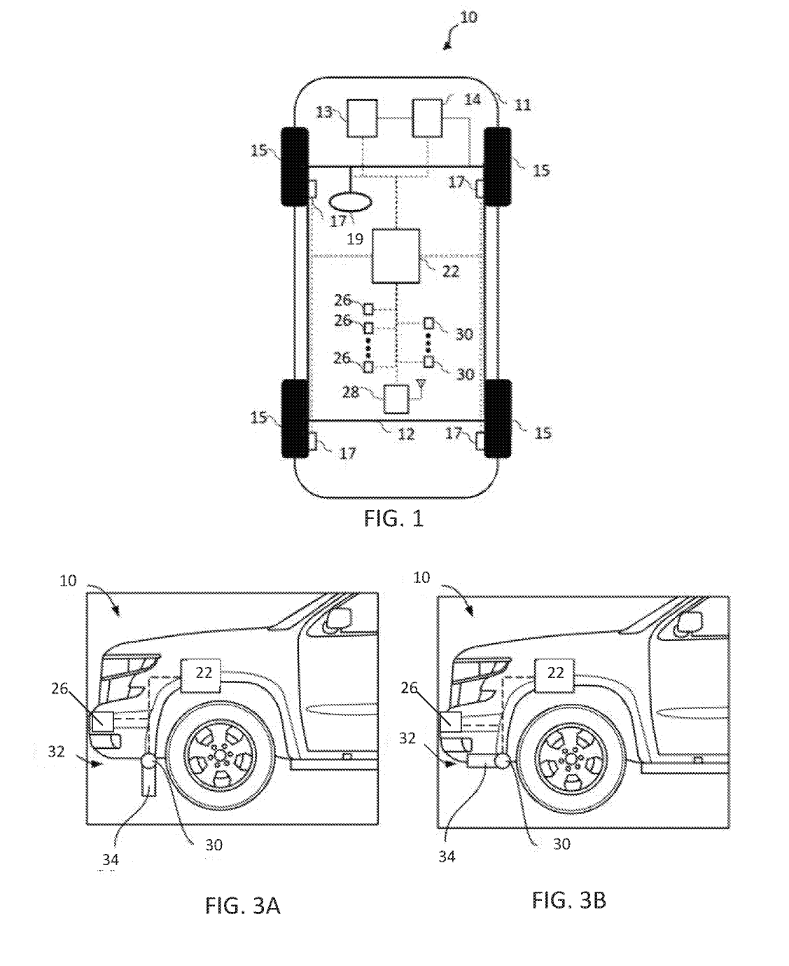

FIG. 1 schematically illustrates an automotive vehicle 10 according to the present disclosure. The vehicle 10 generally includes a body 11 and wheels 15. The body 11 encloses the other components of the vehicle 10. The wheels 15 are each rotationally coupled to the body 11 near a respective corner of the body 11. The vehicle 10 is depicted in the illustrated embodiment as a passenger car, but it should be appreciated that any other vehicle, including motorcycles, trucks, sport utility vehicles (SUVs), or recreational vehicles (RVs), etc., can also be used.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 additionally includes wheel brakes (not shown) configured to provide braking torque to the vehicle wheels 15. The wheel brakes may, in various embodiments, include friction brakes, a regenerative braking system such as an electric machine, and/or other appropriate braking systems. The vehicle 10 additionally includes a steering system 19. While depicted as including a steering wheel and steering column for illustrative purposes, in some embodiments, the steering system 19 may not include a steering wheel.

In various embodiments, the vehicle 10 also includes a navigation system 28 configured to provide location information in the form of GPS coordinates (longitude, latitude, and altitude/elevation) to a controller 22. In some embodiments, the navigation system 28 may be a Global Navigation Satellite System (GNSS) configured to communicate with global navigation satellites to provide autonomous geo-spatial positioning of the vehicle 10. In the illustrated embodiment, the navigation system 28 includes an antenna electrically connected to a receiver.

With further reference to FIG. 1, the vehicle 10 also includes a plurality of sensors 26 configured to measure and capture data on one or more vehicle characteristics, including but not limited to vehicle speed, vehicle heading, etc. In the illustrated embodiment, the sensors 26 include, but are not limited to, an accelerometer, a speed sensor, a heading sensor, gyroscope, steering angle sensor, or other sensors that sense observable conditions of the vehicle or the environment surrounding the vehicle and may include short range or long range RADAR, LIDAR, optical cameras, thermal cameras, ultrasonic sensors, infrared sensors, light level detection sensors, and/or additional sensors as appropriate. In some embodiments, the vehicle 10 also includes a plurality of actuators 30 configured to receive control commands to control steering, shifting, throttle, braking, a position of an active aerodynamic component, or other aspects of the vehicle 10.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

FIG. 2 illustrates an exemplary system 100 for controlling an active aerodynamic component of an automotive vehicle. Once environmental conditions are detected that may lead to an impact of an active underbody component with a road feature, such as a bump, curb, or other obstacle, in some embodiments, the system 100 directs one or more underbody components 28 of the vehicle to move or adjust to minimize the chance of impact with the approaching obstacle. The processor/controller device 22 includes a central processing unit (CPU) 14 coupled to memory devices 16 and 18, which can include such memory as random access memory (RAM) 16, non-volatile read only memory (NVROM) 18, and possibly other mass storage devices. The CPU 14 is coupled through an input/output (I/O) interface 20 to at least one of the plurality of sensors 26, discussed herein with respect to FIG. 1. The sensors 26 are configured to measure various operational parameters of the vehicle and provide data on environmental conditions along a projected path of travel of the vehicle, as will be further described. In some embodiments, the CPU 14 is coupled through the I/O interface 20 to an inertial measurement unit (IMU) including one or more sensors 26. The controller 22 generates one or more control signals and transmits the control signals to the actuators 30, including, for example and without limitation, one or more actuators 30 configured to re-position or move an underbody surface, such as an active aerodynamic surface.

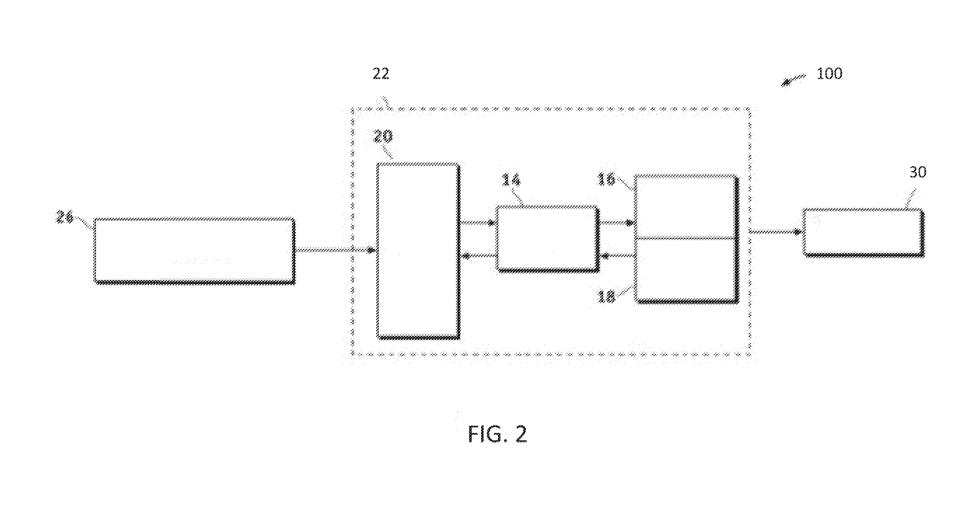

FIGS. 3A and 3B illustrate a partial side view of an automotive vehicle 10 that includes a moveable, or active, underbody aerodynamic surface. In the embodiment of FIGS. 3A and 3B, the vehicle 10 is provided with an underbody feature 32 coupled to the actuator 30 and a sensor 26. The underbody feature 32 includes a moveable surface 34. The actuator 30 and the sensor 26 are each electronically connected to and in communication with the controller 22. The actuator 30 is under the control of the controller 22. The controller 22 is configured to control the actuator 30 to move the moveable surface 34 between a first, or deployed, position, shown in FIG. 3A, and a second, or stowed, position, shown in FIG. 3B. In some embodiments, the moveable surface 34 of the underbody 32 is moved to an intermediate position between the first position and the second position. In some embodiments, as shown in FIGS. 3A and 3B, the actuator 30 is configured to pivot the moveable surface 34 about a pivot. However, as will be appreciated by one of skill in the art, the active underbody surface may be repositioned by lateral, longitudinal, and/or vertical translation relative to the vehicle.

In a first position, illustrated by FIG. 3A, the moveable surface 34 is in a deployed position extending some distance below the underbody of the vehicle 10, thereby reducing the clearance height of the vehicle 10. As the vehicle 10 travels along a roadway, data from the sensor 26, including, in some embodiments, image data from an optical or infrared camera, is received by the controller 22. As the vehicle 10 approaches an obstacle, such as a curb, bump, hole, for example and without limitation, image data of the upcoming obstacle is received by the controller 22. The controller 22 analyzes the image data and determines whether an impact between the detected obstacle and the moveable surface 34 is imminent. In some embodiments, analyzing the image data includes determining one or more dimensions of the upcoming obstacle (including width, height, and depth) and comparing the dimensions to an underbody clearance height of the vehicle, where the underbody clearance is a space between the road surface and the moveable surface 34. If the controller 22 determines that an impact is likely, the controller 22 generates a control signal to control the actuator 30 to move the moveable surface 34 from the deployed position shown in FIG. 3A to the stowed position shown in FIG. 3B, thereby increasing the clearance height of the vehicle 10. Similarly, if the image data received from the sensor 26 by the controller 22 does not indicate an impending impact between an obstacle and the moveable surface 34, the controller 22 controls the actuator 30 to redeploy the moveable surface 34 to the first position.

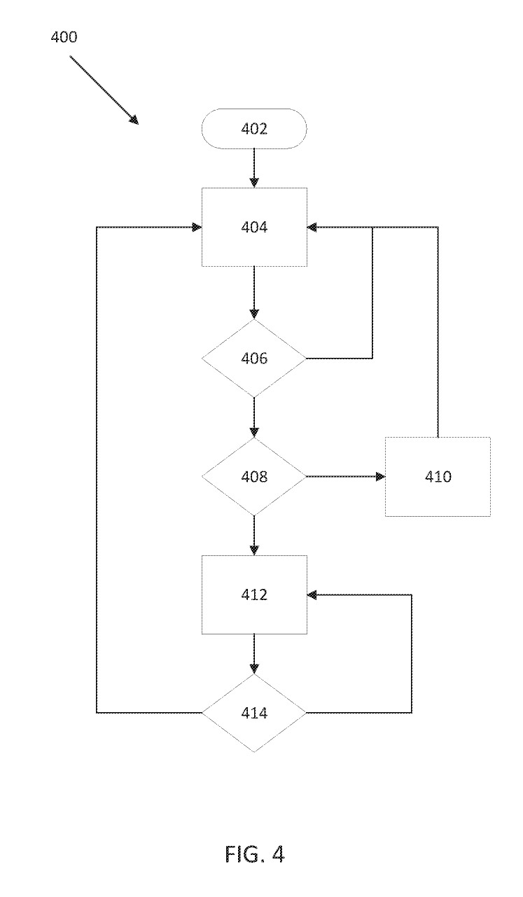

FIG. 4 illustrates an exemplary method 400 for controlling an active aerodynamic component of an automotive vehicle. The method 400 can be utilized in connection with the system 100 having one or more sensors 26 and one or more actuators 30. In an exemplary embodiment, the method is performed by means of programming provided to a controller, e.g. the controller 22 illustrated in FIGS. 1 and 2. The order of operation of the method 400 is not limited to the sequential execution as illustrated in FIG. 4 but may be performed in one or more varying orders, or steps may be performed simultaneously, as applicable in accordance with the present disclosure.

The method 400 begins at 402 and proceeds to 404. At 404, the controller 22 receives sensor data from one or more of the sensors 26. In some embodiments, the sensor data includes details of environmental conditions surrounding the vehicle, and in particular, of an area immediately preceding the vehicle along the vehicle's projected path of travel, for example and without limitation. The data includes, in some embodiments, visual images, infrared images, ultrasonic data, LIDAR or RADAR data, etc., for example and without limitation.

Next, at 406, the controller 22 analyzes the sensor data for obstacles detected along the projected path of travel of the automotive vehicle. In some embodiments, the controller 22 analyzes image data from one or more cameras to identify any obstacles such as potholes, bumps, curbs, animals, or other hazards that could impact an underbody component of the vehicle as the vehicle passes over the obstacle. If an obstacle is not identified, the method 400 returns to 404 and continues as discussed herein.

However, if the controller 22 detects an obstacle along the projected path of the vehicle, the method 400 proceeds to 408. At 408, the controller 22 determines whether the vehicle includes an active aerodynamic component, the current status of the active aerodynamic component (that is, whether the active aerodynamic component is in a deployed or a stowed position) and further, if the active aerodynamic component can be adjusted to a stowed position.

If this determination is negative, the method 400 continues to 410. At 410, the controller 22 controls the actuator 30 to either redeploy the aerodynamic component (if the active aerodynamic component was determined to be in the stowed position) or take no action if the active aerodynamic component cannot be adjusted to a stowed position. From 410, the method 400 returns to 404 and continues as discussed herein.

If the determination at 408 is positive, the method 400 continues to 412. At 412, the controller 22 controls the actuator 30 to adjust the moveable surface 34 of the underbody feature 32 to the stowed position, as shown in FIG. 3B.

From 412, the method 400 proceeds to 414. At 414, the controller 22 determines whether the current position of the moveable surface 34 will avoid the detected obstacle. In some embodiments, the controller 22 reviews the sensor data to determine the dimensions of the detected obstacle and compares this information with an underbody clearance of the vehicle with the moveable surface 34 in the stowed position. If the determination at 412 is positive, the method 400 returns to 404 and continues as discussed herein.

However, if the determination is negative, that is, that there is not sufficient underbody clearance between the underbody feature 32 and the detected obstacle, the method 400 returns to 412 and the controller 22 directs the actuator 30 to further adjust the position of the moveable surface 34, if possible.

Variations on the above are also contemplated within the scope of the present disclosure.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fail within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to he understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may he presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one a the listed alternatives at a time, unless the context dearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of controlling a vehicle, the method comprising:
providing a vehicle having a body with an underbody space between a lower surface of the body and a driving surface;
providing a moveable underbody feature at the lower surface, the moveable underbody feature having a first position and a second position, the first position presenting a deployed profile in the underbody space and the second position presenting a stowed profile in the underbody space, the second position distinct from the first position;
providing an actuator coupled to the moveable underbody feature and configured to drive the moveable underbody feature between the first position and the second position;
providing at least one sensor configured to detect an environmental condition;
providing a controller in communication with the actuator and the at least one sensor; and
in response to the detected environmental condition, automatically moving the moveable underbody feature, via the actuator, between the first position and the second position.

2. The method of claim 1, wherein the environmental condition comprises a detected obstacle along a projected path of travel of the vehicle.

3. The method of claim 1, further comprising, in response to the detected environmental condition, automatically moving the moveable underbody feature, via the actuator, to an intermediate position between the first position and the second position.

4. The method of claim 1, wherein providing at least one sensor comprises providing at least one short range RADAR sensor.

5. The method of claim 1, wherein providing at least one sensor comprises providing at least one long range RADAR sensor.

6. The method of claim 1, wherein providing at least one sensor comprises providing at least one ultrasonic sensor.

7. The method of claim 1, wherein providing at least one sensor comprises providing at least one optical camera.

8. An automotive vehicle, comprising:
a body having a lower surface;
a plurality of vehicle wheels disposed at the lower surface, each respective wheel of the plurality of wheels having a respective contact surface for contacting a driving surface, an underbody space being defined between the contact surfaces and the lower surface of the body;
a moveable underbody feature coupled to the lower surface and projecting into the underbody space, the moveable underbody feature having a first position and a second position, the first position presenting a deployed profile in the underbody space and the second position presenting a stowed profile in the underbody space, the second position distinct from the first position;
at least one sensor configured to capture sensor data representing a vehicle environment;
an actuator coupled to the moveable underbody feature and configured to drive the moveable underbody feature between the first position and the second position; and
a controller in communication with the at least one sensor and the actuator, the controller configured to analyze the sensor data for an environmental condition and, if the analyzed data includes the environmental condition, control the actuator to move the moveable underbody feature from the first position to the second position.

9. The automotive vehicle of claim 8, wherein the moveable underbody feature additionally has an intermediate position between the first position and the second position, and wherein the controller is further configured to, in response to the environmental condition, control the actuator to move the moveable underbody feature to the intermediate position.

10. The automotive vehicle of claim 8, wherein the at least one sensor includes an optical camera configured to capture image data of an area along a projected path of travel of the vehicle, wherein the environmental condition comprises an obstacle identified along the projected path of travel.

11. The automotive vehicle of claim 8, wherein the at least one sensor includes a short range RADAR sensor configured to capture data of an area along a projected path of travel of the vehicle, wherein the environmental condition comprises an obstacle identified along the projected path of travel.

12. The automotive vehicle of claim 8, wherein the at least one sensor includes a long range radar configured to capture data of an area along a projected path of travel of the vehicle, wherein the environmental condition comprises an obstacle identified along the projected path of travel.

13. The automotive vehicle of claim 8, wherein the at least one sensor includes an ultrasonic sensor configured to capture data of an area along a projected path of travel of the vehicle, wherein the environmental condition comprises an obstacle identified along the projected path of travel.

14. A method for controlling a vehicle, the method comprising:
receiving, by a vehicle controller, sensor data representing a vehicle environment along a projected path of travel of the vehicle from at least one sensor;
determining, by the vehicle controller, if the projected path of travel of the vehicle includes an obstacle;
determining, by the vehicle controller, if an underbody component of the vehicle will impact the obstacle; and
if the underbody component will impact the obstacle, generating, by the vehicle controller, a control signal to move the underbody component from a first position to a second position.

15. The method of claim 14, wherein receiving data from at least one sensor comprises receiving image data from an optical camera and wherein determining if the projected path of travel of the vehicle includes an obstacle comprises analyzing, by the vehicle controller, the image data received from the optical camera to identify the obstacle.

16. The method of claim 14, wherein determining if an underbody component of the vehicle will impact the obstacle comprises comparing, by the vehicle controller a clearance height of the vehicle with an estimated height of the obstacle, wherein the estimated height of the obstacle is determined from the sensor data.

17. The method of claim 14, wherein receiving data from at least one sensor comprises receiving data from a RADAR sensor and wherein determining if the projected path of travel of the vehicle includes an obstacle comprises analyzing, by the vehicle controller, the data received from the RADAR sensor to identify the obstacle.

18. The method of claim 14, wherein receiving data from at least one sensor comprises receiving data from an ultrasonic sensor and wherein determining if the projected path of travel of the vehicle includes an obstacle comprises analyzing, by the vehicle controller, the data received from the ultrasonic sensor to identify the obstacle.
